(19) United States
(12) Patent Application Publication
(10) Pub. No.: US 2002/0087903 A1
(43) Pub. Date: Jul. 4, 2002

(54) Mechanism for managing power generated in a computer system

(76) Inventors: James Hermerding, San Jose, CA (US); Randy Stanley, Aptos, CA (US)

Correspondence Address: Mark L. Watson, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/752,575

(22) Filed: Dec. 29, 2000

(51) Int. Cl. G06F 1/26; G06F 1/32

(52) U.S. Cl. 713/320

(57) ABSTRACT

According to one embodiment, a method of managing power generated within a computer system, the method includes operating the computer system at a first central processing unit (CPU). Subsequently, a first signal generated by a thermal sensor within the first CPU is received and operation of the computer system at is resumed at a second CPU.

### FIELD OF THE INVENTION

The present invention relates to computer systems; more particularly, the present invention relates to power management of computer systems.

### BACKGROUND

Traditionally, the power generated by microprocessors in mobile computers systems (e.g., notebook computers) was of little concern because of the relatively low speeds at which they operate. However, with the continuous increase of the operating speeds of microprocessors, the power generated by the microprocessor makes cooling the computer system more difficult. For example, typical microprocessors in mobile computer systems generate between 20-30 watts in a one-inch form factor. The generation of this magnitude of power at a small location may potentially create thermal issues at the memory device.

FIG. 2 illustrates an exemplary cooling system used in notebook computers. The cooling system includes a block coupled to a microprocessor, a heat pipe, a heat exchanger and a cooling fan. Heat generated by the microprocessor is distributed to the heat pipe, which in turn, transfers the heat to the heat exchanger. Subsequently, the heat exchanger is cooled by air blown by the cooling fan. The problem with conventional cooling systems is that it is difficult to dissipate heat generated by more powerful microprocessors in such a small area. Therefore, a method and apparatus for managing the power generated by microprocessors is desired.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of one embodiment of a computer system;

FIG. 2 illustrates an exemplary cooling system;

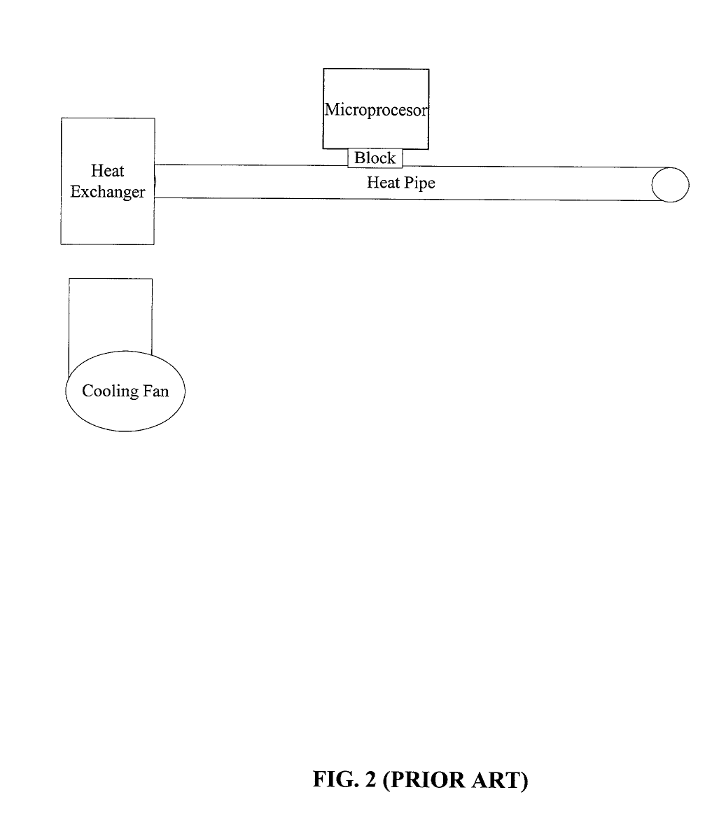

FIG. 3 illustrates one embodiment of a cooling system within a computer system; and

FIG. 4 is a flow diagram of one embodiment for the operation of a computer system.

### DETAILED DESCRIPTION

A method and apparatus for managing power generated by microprocessors is described. In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

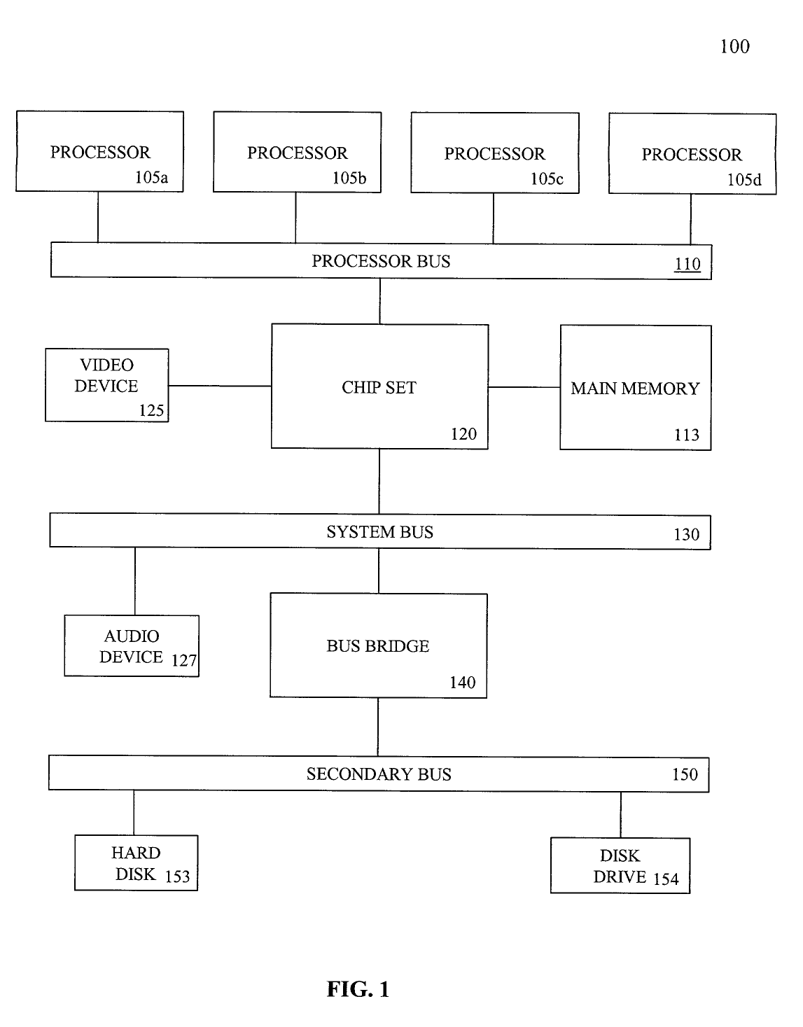

FIG. 1 is a block diagram of one embodiment of a computer system 100. According to one embodiment, computer system 100 is a mobile computer system (e.g., laptop, notebook, etc.). Computer system 100 includes central processing units (processors) 105a-105d coupled to a processor bus 110. In one embodiment, processors 105 are processors in the Pentium® family of processors including the Pentium® II family and mobile Pentium® and Pentium® II processors available from Intel Corporation of Santa Clara, Calif. Alternatively, other processors may be used.

Chip set 120 is also coupled to processor bus 110. Chip set 120 may include a memory controller for controlling a main memory 113. Further, chipset 120 may also include an Accelerated Graphics Port (AGP) Specification Revision 2.0 interface developed by Intel Corporation of Santa Clara, Calif. Chip set 120 is coupled to a video device 125 and handles video data requests to access main memory 113. One of ordinary skill in the art will appreciate that, in other embodiments, each processor 105 may be directly coupled to chipset 120, rather than via processor bus 110.

Main memory 113 is coupled to processor bus 110 through chip set 120. Main memory 113 stores sequences of instructions that are executed by processor 105. In one embodiment, main memory 113 includes a dynamic random access memory (DRAM) system; however, main memory 113 may have other configurations. The sequences of instructions executed by processor 105 may be retrieved from main memory 113 or any other storage device. Additional devices may also be coupled to processor bus 110, such as multiple processors and/or multiple main memory devices. Video device 125 is also coupled to chip set 120. In one embodiment, video device includes a video monitor such as a cathode ray tube (CRT) or liquid crystal display (LCD) and necessary support circuitry.

Processor bus 110 is coupled to system bus 130 by chip set 120. In one embodiment, system bus 130 is a Peripheral Component Interconnect (PCI) Specification Revision 2.1 standard bus developed by Intel Corporation of Santa Clara, Calif.; however, other bus standards may also be used. Multiple devices, such as audio device 127, may be coupled to system bus 130.

Bus bridge 140 couples system bus 130 to secondary bus 150. In one embodiment, secondary bus 150 is an Industry Standard Architecture (ISA) Specification Revision 1.0a bus developed by International Business Machines of Armonk, N.Y. However, other bus standards may also be used, for example Extended Industry Standard Architecture (EISA) Specification Revision 3.12 developed by Compaq Computer, et al. Multiple devices, such as hard disk 153 and disk drive 154 may be coupled to secondary bus 150. Other devices, such as cursor control devices (not shown in FIG. 1), may be coupled to secondary bus 150.

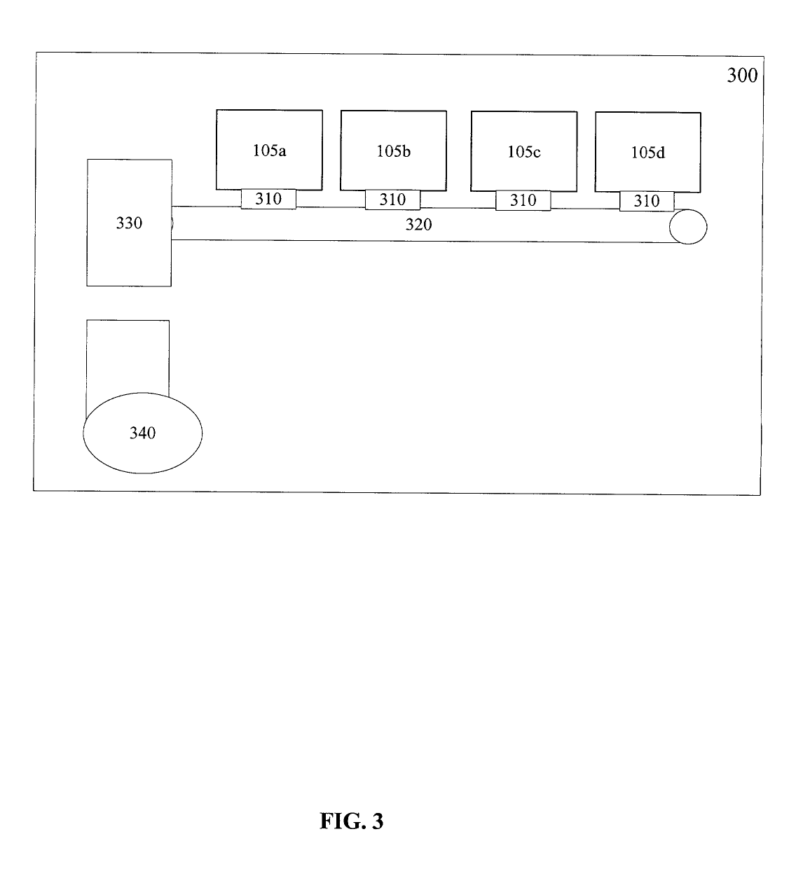

FIG. 3 illustrates one embodiment of a cooling system 300 within computer system 100. Cooling system 300 includes blocks 310, heat pipe 320, heat exchanger 330 and cooling fan 340. A block 310 is coupled to each of the processors 105. According to one embodiment, blocks 310 are made of copper. However, one of ordinary skill in the art will appreciate that blocks 310 may be made of other materials. Heat pipe 320 is coupled to each processor 105 via blocks 310.

According to one embodiment, heat pipe 320 is a hollow copper tube filled with a small amount of liquid such as water. In a further embodiment, heat pipe 320 maintains a vacuum. Since water boils rapidly in a vacuum, the water becomes vapor upon being heated by a processor 105, and is transferred away from the point where the heat is being generated. Therefore, heat generated by each processor 105 is transferred by heat pipe 320. Heat exchanger 330 dissipates the heat transferred by heat pipe 320. Cooling fan 340 further dissipates the heat by blowing air across heat exchanger 330.

According to one embodiment, computer system 100 is arranged such that instruction tasks are moved between processor 105a-105d based upon the heat being generated at each. In such an embodiment, each processor 105 includes a thermal sensor that provides thermal feedback to the operating system that runs on computer system 100. Based upon the feedback, the operating system makes decisions on how to partition the workload among the processors 105.

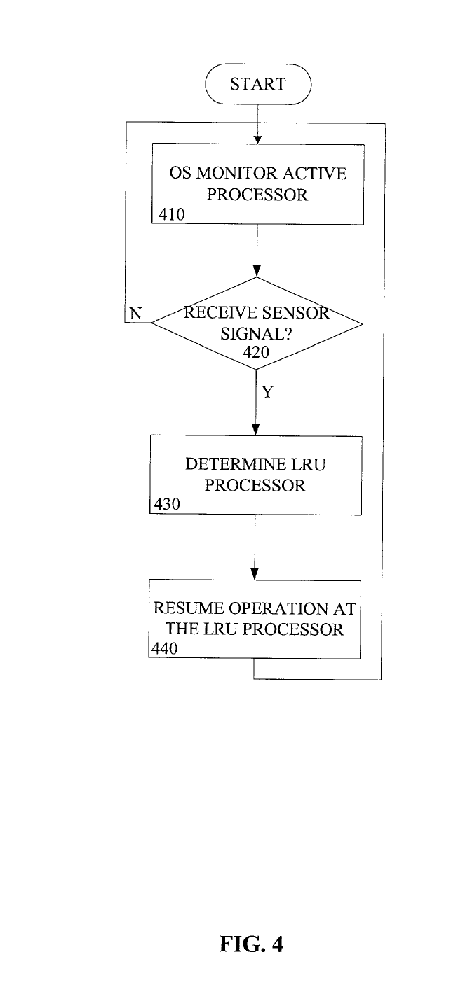

FIG. 4 is a flow diagram of one embodiment for the operation of computer system 100. At process block 410, the operating system for computer system 100 monitors the currently active processor 105 to determine the thermal state. In one embodiment, the operating system receives a thermal signal from the active processor 105 once the processor 105 has reached ¼ of its power capacity. However, in other embodiments the thermal signal may be transmitted upon reaching other increment levels of the power capacity of a processor 105.

At process block 420, it is determined whether the active processor 105 is generating the thermal signal. If the thermal signal is not being transmitted, the active processor 105 is operating below the predetermined thermal threshold. As a result, control is returned to process block 410 where the operating system continues to monitor the active processor 105. If, however, it is determined that the thermal signal is being transmitted, the least recently used (LRU) processor 105 in computer system 100 is determined, process block 430.

According to one embodiment, the LRU processor 105 is the processor 105 that has been inactive for the longest interval of time. At process block 440, computer system 100 operations continue at the new active processor 105 (e.g., the LRU processor 105). Moving the processor 105 workload between multiple processors 105 distributes the heat generated by the processors within computer system 100. For example, rather than having one processor 105 generate 20 watts of power, the 20 watts may be distributed evenly between multiple processors 105. In the present embodiment, computer system 100 operates so that 5 watts is generated by each of the processors 105a-105d. Cooling system 100 may more easily distribute the four different 5-watt sources than one 20-watt source.

In another embodiment, computer system 100 distributes tasks between processor 105a-105d based upon the heat being generated at each. In such an embodiment, the operating system includes multiple threads that partition the workload so that one processor 105 does not overheat. Based upon thermal feedback received from each processor 105, the operating system prioritizes the workload based upon the coolest processor 105. Distributing instruction tasks between processors 105 enables cooling system 300 to more easily dissipate heat generated by processors 105.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

Therefore, a mechanism for managing the power generated by microprocessors has been described.

What is claimed is:

1. A method of managing power generated within a computer system, the method comprising:
operating the computer system at a first central processing unit (CPU);
receiving a first signal generated by a thermal sensor within the first CPU; and
resuming operation of the computer system at a second CPU.

2. The method of claim 1 further comprising determining a least recently used (LRU) CPU in the computer system upon receiving the signal from the first CPU.

3. The method of claim 2 wherein the second CPU is the LRU CPU.

4. The method of claim 2 further comprising:
receiving a second signal generated by a thermal sensor within the second CPU;
determining a CPU in the computer system; and
resuming operation of the computer system at a third CPU.

5. A computer system comprising:
a first central processing unit (CPU); and
a second CPU, wherein the operation of the computer system is transferred from the first CPU to the second CPU upon the first CPU reaching a predetermined power threshold.

6. The computer system of claim 5 wherein the first CPU and the second CPU each include a thermal sensor.

7. The computer system of claim 6 wherein the operation of the computer system is transferred from the first CPU to the second CPU upon the thermal sensor within the first CPU measuring the predetermined power threshold.

8. The computer system of claim 5 further comprising a cooling system.

9. The computer system of claim 8 wherein the cooling system comprises:
a heat pipe coupled to the first CPU and the second CPU;
a heat exchanger; and
a cooling fan.

10. The computer system of claim 1 further comprising a third CPU, wherein the operation of the computer system is transferred from the second CPU to a least recently used (LRU) CPU upon the second CPU reaching a predetermined power threshold.

11. The computer system of claim 10 wherein the third CPU is the LRU CPU.

12. A cooling system comprising:
a heat pipe; and
a first central processing unit (CPU) coupled to the heat pipe, wherein the first CPU is active until reaching a predetermined power threshold.

13. The cooling system of claim 12 further comprising a second CPU, wherein the second CPU becomes active upon the first CPU reaching the predetermined power threshold.

14. The cooling system of claim 12 further comprising:
a second CPU; and
a third CPU, wherein a least recently used (LRU) CPU becomes active upon the first CPU reaching the predetermined power threshold.

15. The cooling system of claim 14 wherein the third CPU is the LRU CPU.

16. The cooling system of claim 12 further comprising:
a block coupled between the first CPU and the heat pipe;
heat exchanger; and
a cooling fan.
